(19) United States
(12) Patent Application Publication
(10) Pub. No.: US 2011/0030226 A1
(43) Pub. Date: Feb. 10, 2011

(54) Ceramic razor blade

(76) Inventor: Michael Dunn-Rankin, Venice, FL (US)

Correspondence Address: Michael Dunn-Rankin, 1158 Fundy Rd., Venice, FL, 34293, US

(21) Appl. No.: 12/462,519

(22) Filed: Aug. 5, 2009

(51) Int. Cl. B26B 21/54

(52) U.S. Cl. 30/346.53

(57) ABSTRACT

Disclosed is a razor or cutting blade of a thin sheet-like construction having a ceramic material contained therein. The blade is either wholly made of a ceramic material or has a coating of ceramic material thereon. The blade may be made of many different shapes, such as a rectangle a trapezoid. The blade may have a metal ridge on one edge of the rectangle while the other longitudinal edge is sharpened. The trapezoid construction may have the long edge sharpened in addition to one of the slanted edges. Any of the blades may have notches in non-sharpened edges thereof to act as locating guides when placed in a manipulating handle.

### BACKGROUND OF THE INVENTION

There are many razor blades of various configurations that may used as a single blade or contained in a cartridge to be interchanged with an existing blade or a blade may be doubled or tripled up on top of a handle and is readily available and easily interchanged if the need arises. However, all of these above mentioned razor blades are made of steel or some kind of metal and therefore, may easily be subjected to rusting because a razor and therefore the razor blade is used in a wet environment. An extensive search revealed that there are no razor blades made of a ceramic material or coated with a ceramic. U.S. Pat. No. 5,018,274 discloses a razor implement that is made of a ceramic material but it cannot be termed a thin razor blade because it is constructed of a small but rigid block of ceramic having a plurality of substantially parallel cells therein representing a honeycomb pattern. The surface of the cell is ground and polished to thereby obtain a plurality cutting edges. This is a totally different instrument for shaving when compared to all other flexible and thin blades. Ceramic cutting instruments are known such as knifes used in cutting vegetables and or meats. However these cutting instruments are rigid and cannot be used in the identified environment.

### BRIEF DESCRIPTION OF THE INVENTION

The inventive razor or cutting blade is made of a ceramic material that defies rusting in a wet environment but remains flexible to the extent all other steel or metal razor blades. This inventive ceramic razor or cutting blade may be expanded to include all other known and different type of blades. Sharpened edges of ceramic cutting instruments, such as knifes, are known to remain in their sharpened state much longer and this applies equally well to the inventive ceramic razor blades. In a different embodiment the ceramic material may be applied to steel or metal razor blades as a coating.

### BRIEF DESCRIPTION OF THE DRAWINGS

FIG. 1 illustrates a basic straight razor blade having a ridged edge at one end thereof;

FIG. 2 shows a second embodiment having slanted edges;

FIG. 3 shows a third embodiment having notches at an upper edge;

FIG. 4 shows a fourth embodiment having notches at side edges;

FIG. 5 is a fifth embodiment having notches at an upper edge and having a sharpened additionally slanted edge.

FIGS. 2, 3 and 5 show the blade in a trapezoidal shape.

### DETAILED DESCRIPTION OF THE INVENTION

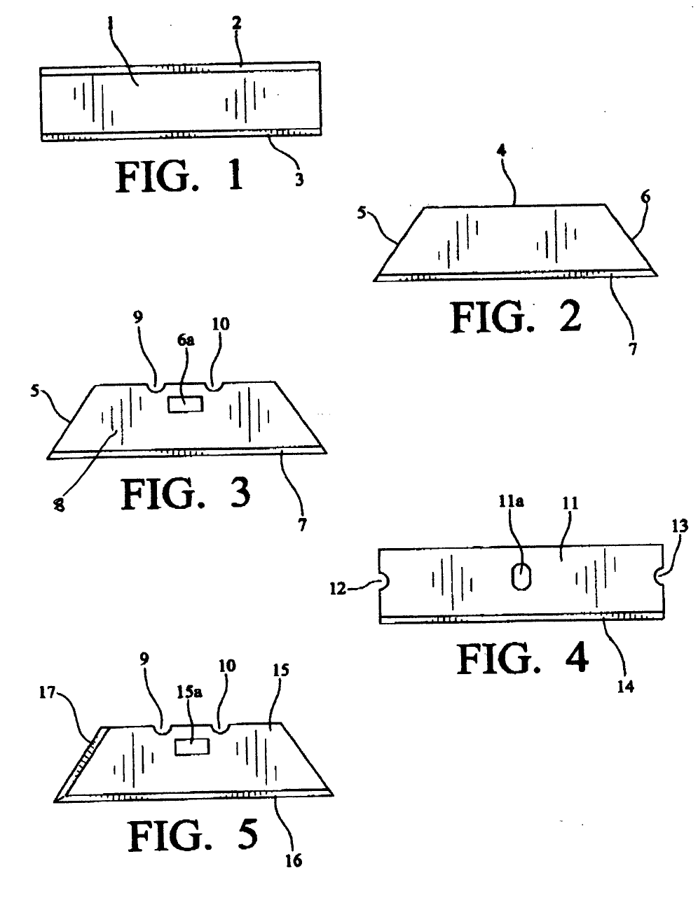

FIG. 1 shows the conventional and rectangular structure of a known razor blade 1 having a sharpened edge 3 at one side thereof and having metal ridge or backing 2 that is attached to the opposite side of the sharpened edge of the blade. This type of razor blade is well known and may be attached to a handle to shave or to cut or it may be attached to a different handle that exposes the cutting edge to act as a cutting instrument.

The material employed in forming the blade can be selected from the group of ceramic material consisting of zirconia, tetragonal circonia, partially stabilized zirconia, zirconia stabilized alumina, cordierite, mullite, boron cordite, titanium nitride, silicon nitride and aluminum oxide.

FIG. 2 illustrates a razor blade 4 in the form of a trapezoid. The thin piece of material containing a ceramic material has a straight cutting edge 7 and two slanted side edges 5 and 6.

FIG. 3 shows the same razor blade 8 as shown in FIG. 2 in the shape of a trapezoid. In addition to the straight cutting edge 7 there are two notches 9 and 10 on the opposite edged from the cutting edge 7. The notches are used as locators to place the blade in a predetermined location and as stabilizers and the hole or opening 6a is used tp fix the blade in a manipulating handle.

FIG. 4 illustrates a rectangular blade 11 having a sharpened edge 14 in the longitudinal direction. On each of the narrow side edges there are two notches 12 and 13 again to be used as locators an a manipulating handle and a hole 11a to be used as a fastener when the blade 11 is located in a handle.

FIG. 5 discloses a razor blade 15 again in a trapezoidal shape having a sharpened cutting edge located on the long edge of the trapezoid. There is a further cutting 17 located on one of the slanted edges of the trapezoid. The short edge of the trapezoid again has two notches 9 and 10 as were shown in FIG. 3 and again a fastening hole 15a.

All of the blades disclosed in FIGS. 1-5 may cast in molds or may cut from cast sheets. The cutting edges may be sharpened with grinding or buffeting tools or by other means. The edge may created sharp in the mold or by a cutting of the blade from a sheet when the blade is manufactured.

As is well known these types of razor blades may used in an appropriate handle just for shaving or may be incorporated in handles for cutting purposes such as card board, sheet rock, wires, plastic materials, flooring or any other various materials. The cutting edges need to sharp and maintain sharp to create an advantage in slicing or cutting materials.

In manufacturing the above disclosed blades it is also advisable that the razor or cutting blade may be made with a coating of a ceramic material. This coating may be of any predetermined thickness including a a thickness of molecular material. The ceramic covering may be applied to plastic, ceramic, steel or other alloys. The coating may include the entire blade or a partial portion of the blade, especially the cutting edge of the blade.

It can now be seen that the use of ceramics is desirable because of the inherent quality of ceramics which are known to be rustproof and it is foreseen that the cutting edges will remain sharper much longer than metal, such as steel blades. The ceramic material is rigid in a sheet configuration, such as is contemplated for use in razor blades. It has also been experienced that the cutting edges retain their sharpness much longer than conventional razor or cutting blades. The ceramic blades can also be sterilized by using higher temperatures than can be tolerated by metal including steel.

What I claim is:

1. A razor or cutting blade constructed of substantially thin sheet material and having a ceramic material contained therein, said razor or cutting blade having at least one sharpened edge thereon.

2. The razor or cutting blade of claim 1, wherein said ceramic material is fully contained in said razor or cutting blade.

3. The razor or cutting blade of claim 1, wherein said ceramic material is a coating on said razor or cutting blade.

4. The razor or cutting blade of claim 1 wherein said razor or cutting blade has a shape of a rectangle with one long edge of said rectangle having said sharpened edge thereon.

5. The razor or cutting edge blade of claim 1, wherein said razor or cutting blade has a shape of a trapezoid with a long edge of said trapezoid having said sharpened edge thereon.

6. The razor or cutting blade of claim 5, wherein said razor or cutting blade further includes a sharpened edge on a slant of said trapezoid.

7. The razor or cutting blade of claim 4, wherein the other of said longitudinal edge has a metal ridge thereon.

8. The razor or cutting blade of claim 1, wherein other edges of said blade have notches therein as a means for locating said raozr or cutting blade in a handling tool.
